(19) United States
(12) Patent Application Publication
(10) Pub. No.: US 2009/0019980 A1
(43) Pub. Date: Jan. 22, 2009

(54) MACHINE FOR CUTTING FABRIC SHEETS FOR ROLLER BLINDS

(75) Inventor: Lars V. Hansen, Ringe (DK)

Correspondence Address: PEARNE & GORDON LLP, 1801 EAST 9TH STREET, SUITE 1200, CLEVELAND, OH, 44114-3108, US

(73) Assignee: Benthin A/S, Ryslinge (DK)

(21) Appl. No.: 11/813,371

(22) PCT Filed: Jan. 9, 2006
(86) PCT No.: PCT/DK06/00012

§ 371 Date: Aug. 26, 2008

(30) Foreign Application Priority Data
Jan. 9, 2005 (DK) PA200500032

(51) Int. Cl. B26D 7/06

(52) U.S. Cl. 83/107

(57) ABSTRACT

Roller blinds manufactured from rolls of fabric require cutting of the fabric corresponding to the width of the finished roller blind. Traditionally, a cutting device suitable for the fabric is mounted on the cutting machine, and it is also used even when less suitable for a particular fabric. Compound fabrics are traditionally manufactured in a completely different manner. According to the invention, a fast-acting change-over is obtained between two or more cutting devices so that the active cutting device is always an appropriate cutting device. Compound fabrics may be cut with a change-over during what becomes a continuous cutting operation.

The invention relates to a machine for cutting fabric sheets for roller blinds, comprising a storage roll for roller blind fabric, a measuring table, means for immobilizing the fabric sheet, and cutting means travelling in an essentially straight line for cutting to size.

The invention further relates to a use of such a machine.

Roller blinds are made from rolls of roller blind fabric that is manufactured in given widths corresponding to the height of the finished roller blind. Such a storage roll is placed in an unwinding unit on the cutting machine, and the fabric is drawn across a measuring or cutting table, to rest against a ruler that defines the width of the finished roller blind. The measuring table essentially consists of a large plane surface with a slit, through which a cutting device may protrude, either from above or from below. The distance between the ruler and the line along which a cutter shall cut across the fabric defines the width. Dedicated rails or other clamping devices ensure the fixation of the fabric during the cutting. Subsequent to cutting the fabric is fixed to a roller blind roller, it is rolled, and a suitable finishing is applied.

A machine of this type must be able to accommodate all kinds of textiles, webs, and foils in order to be able to manufacture the many types of roller blind that are used in housing as well as professionally. The fabric types are typically starched cotton with varying content of polyester fibre, nylon fibre, or glass fibre, either in the individual threads or as a reinforcement. Furthermore various synthetic polymer foils are used, similar to rubberized cloth. For design reasons combined or compound fabrics are also used, in which different types are welded or cemented together in order to obtain particular visual effects.

All the fabric types may be impregnated with various chemicals, such as fire retardants, dirt repellents, or UV stabilizers. Furthermore, many roller blind fabrics are coated with a layer of polymer.

Various types of cutters are known for use with roller blind fabrics, such as rotating knives or shears, hot wires, ultrasonic cutters, and laser cutters. Unfortunately, these are not universally applicable. For instance, the cutting of fibres with a tendency to splitting may advantageously occur by means of an ultrasonic cutter that seals the cut fibre ends. However, this system cannot be used for polymer sheet or glass fibre reinforced fabrics. In these cases, a high-speed rotating circular knife would be used, cutting against a wear resistant support. The cutting speed that determines the time consumed in cutting a width of a roller blind is very different for the various combinations of fabric types and cutting systems. The use of a cutting device that is not suited for the task means a shorter working life for the active edges and an increased need for cleaning the various surfaces.

Modern manufacture of roller blinds is production to order or for a project, rather than series production, and for this reason a machine must be able to be quickly adapted to the various dimensions, but equally to the various types of roller blind fabric. In practice, this means that a cutting device must be installed according to the task at hand, and this habitually occurs by dismounting the cutting system that is not to be used, including any electrical or pneumatic connections for power supply. Subsequently the particular cutting device that is suited for the task is fitted. However, the time consumption for exchanging the cutting device is of such an order of magnitude, e.g. five minutes, that it is frequently preferred to make use of a cutting device that is already in place, although it may in practice cut much slower. The reason is that the time for exchanging the cutting device must be added to the cutting time of a more suitable cutting device. This means that even when the production is planned for as few switches of cutting device as possible, there is a considerable reduction in capacity, and it may be necessary to erect two machines to operate in tandem.

A particular type of roller blind fabric requires a partially manual cutting with the cutting machines presently available. This relates to the case of compound fabrics, in which fabrics possessing different qualities and surface structures are welded or otherwise joined to one sheet according to a desired design, in order to obtain a desired particular structural effect. Procedures are known in which each type is cut separately, whereupon they are joined by welding or cementing to a complete sheet of the intended dimensions. However, such procedures are not suitable for serial production or order production, in which the width of the finished roller blind is the major variable.

The above discussed disadvantages in known constructions are avoided by a cutting machine according to the invention. This machine is particular in that the cutting means consist of two or more cutting devices that are mounted on support means interconnected in such a manner that only one cutting device at a time may be brought into an active position. An active position is the position where the cutting device in question is placed correctly with respect to the fabric in order that a clean cut is obtained. In practice it may be of less importance whether the active positions represent identically the same point on a given piece of fabric, but they must be at the same height above the measuring table, corresponding to the thickness of the fabric, and at the same distance from the ruler that defines the width of the finished roller blind. The actual change-over between cutting devices may take as little as one second.

In an advantageous embodiment of the invention the support means is a rotatable support in order that each cutting device may be brought into an active position by simple rotation of the support.

The mounting of the cutting devices for fast and reliable change-over may occur in various ways, that each have their respective advantages. In all cases secure indexing mechanisms must be in operation in order to maintain the active position throughout the cutting operation.

One mounting is particular in that the cutting devices are placed on a plane support rotatable around an axis parallel to the plane of the measuring table and perpendicular to the line of cutting. In practice, this means that the cutting devices could sit on a wheel, said wheel being rotated a half revolution (if two cutting devices are installed) to change-over, or they could sit adjacent to each other on a sector of a wheel that would only require a smaller angular movement.

Dependent on the physical structure of the cutting devices and the support they require, the wheel may be supplanted by a cylinder, and one embodiment is particular in that the cutting devices are placed on a cylindrical support rotatable around an axis parallel to the plane of the measuring table and perpendicular to the line of cutting.

A further advantageous embodiment is particular in that the cutting devices are placed on a support that forms part of a rotatable frusto-conical surface in such a manner that each cutting device may be brought into the active position by rotating the conical support. This embodiment permits easier access to the cutting devices that are not in their active position, because they are not only swung out of the plane of cutting but also sideways. Such easier access will facilitate cleaning of cutting devices when not in operation.

In an advantageous embodiment the active position for each of the cutting devices is essentially the same with respect to the other parts of the machine, irrespective of the actual cutting device brought into the active position. This means that full advantage may be taken of the short change-over time in connection with the use of compound fabrics, because the change-over may occur during the cutting itself, corresponding to the actual fabric that the cutting device is about to encounter. A control unit keeping track of fabric texture changes may control the change-over to a different cutting device that is optimal for the particular type of fabric.

The change-over may occur by several means of activation, pneumatic means being preferred because of the speed of operation.

The use of a machine as described above is specified in the claims and will be understood with reference to the detained description below.

The invention will be described in greater detail with reference to the drawing, in which

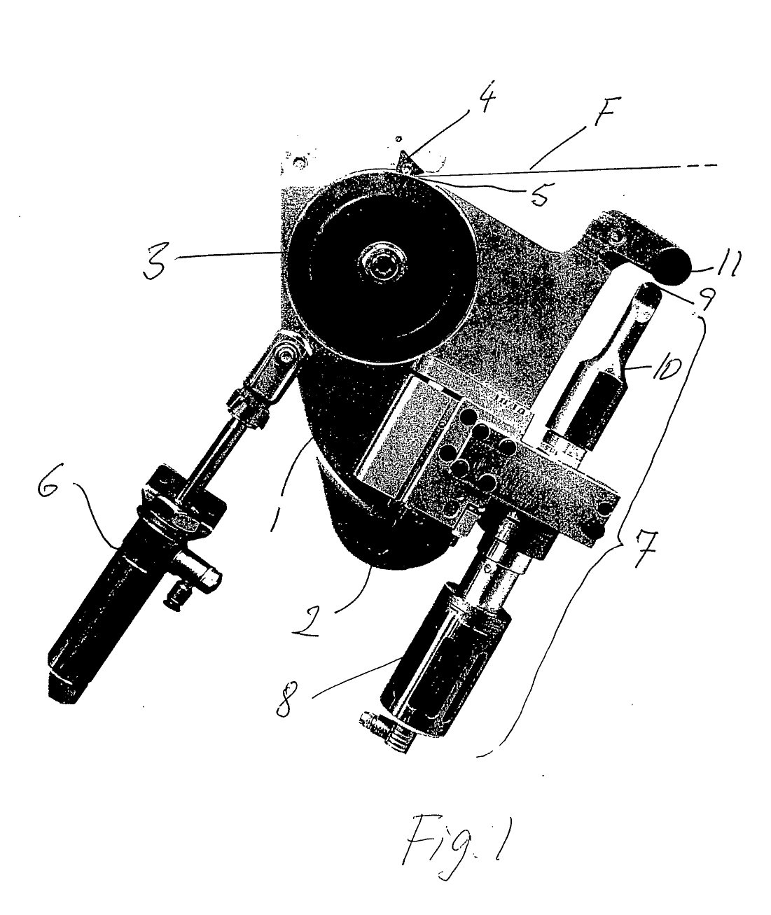

FIG. 1 shows a cutting device of a first type in the active position,

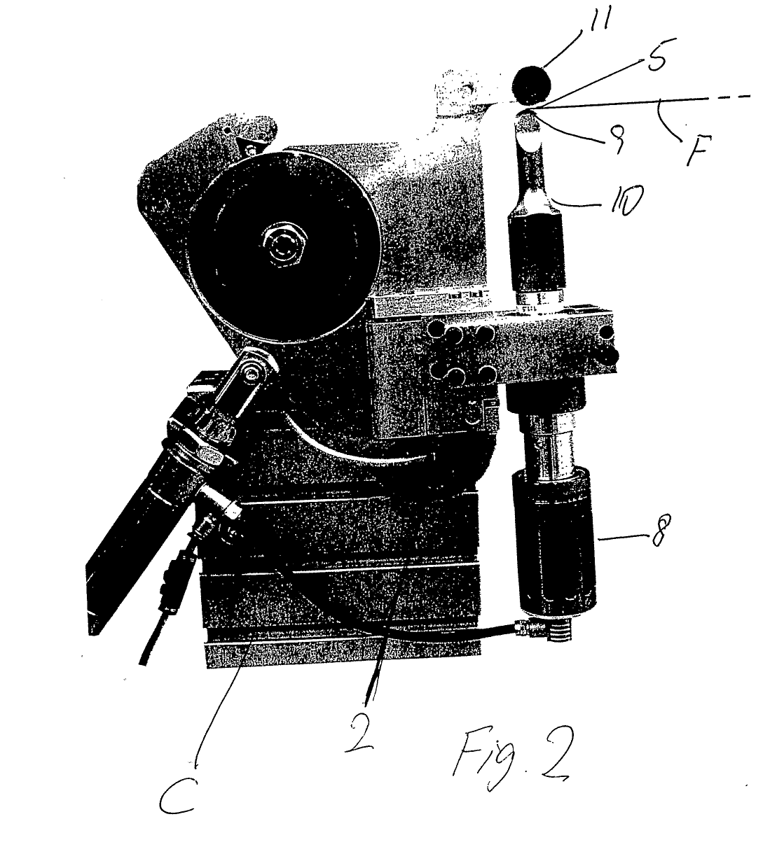

FIG. 2 shows a cutting device of a second type in the active position,

FIG. 3 shows a longitudinal section through a cylindrical support for two cutting devices, and

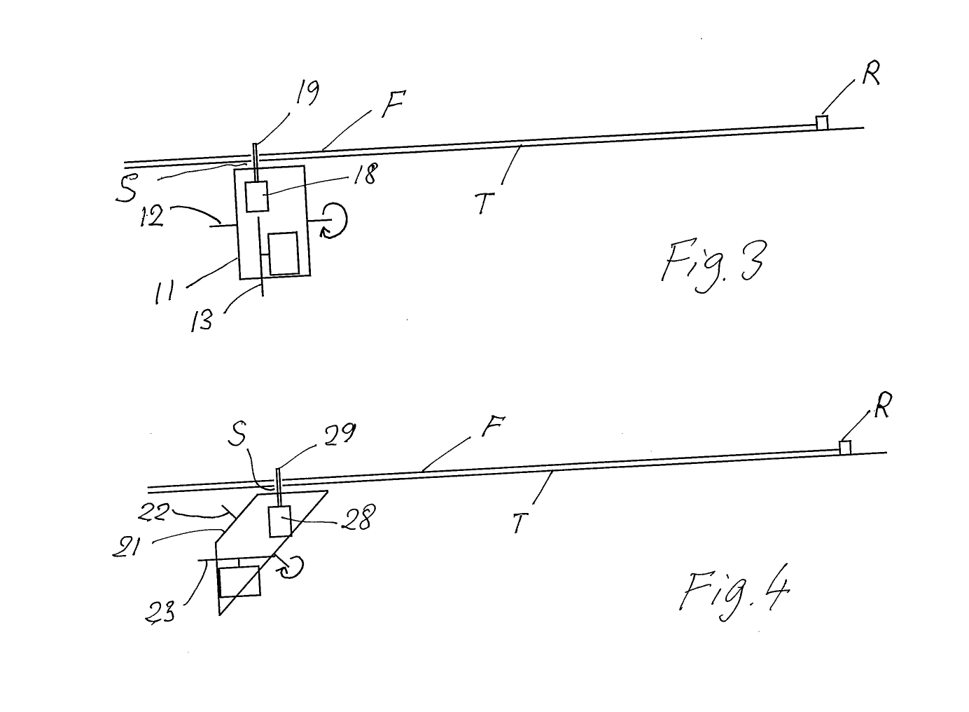

FIG. 4 shows a longitudinal section through a frusto-conical support for two cutting devices.

In FIG. 1 is shown a mounting platform 1 that is carried by massive bearings on an axis of rotation 2. A rotating knife 3 is mounted on this platform together with a fixed knife 4, creating an active cutting position 5. Roller blind fabric F is placed as shown, and during cutting the cutting position 5 is moved to the right, because the whole platform is moved to the right by means that are not shown. Such means may comprise a carriage running on rails. In the position of the platform 1 that is shown here, a pneumatic cylinder 6 has lifted the rotating knife 3 into the active position. Furthermore an ultrasonic cutter 7 is shown. Its functioning principle is that an ultrasound vibrator 8 provides energy to a knife 9 via a horn 10 that acts as a velocity transformer, and it works against an anvil 11 in the usual manner by nipping and sealing fibre ends.

FIG. 2 shows the same elements as in FIG. 1, and furthermore the carriage C upon which the cutting devices are fitted in order to perform the cutting operation. In this case the pneumatic cylinder 6 is in its retracted position, and the rotating knife 3 in in the lowered position, while the ultrasonic cutter 9 has been lifted to the plane F of the fabric and is hence in its active position. The movement of the carriage occurs as described above.

In FIG. 3 it is seen how the support 11 for the cutting devices takes the form of a cylindrical framework rotatable around the axis of rotation 12. The bearing support for the axis of rotation 12 is not shown, but it is fitted to the carriage that transports the cutting device in its cutting movement. The view is from one end of the measuring table, and the slit S and ruler R as well as the fabric F are identified. The cutting table T is shown, but without any indication of its support on legs, etc. The active position is taken by the cutting device 18, 19 that is currently in the topmost position adjacent to the fabric F. An indexing mechanism to maintain this position is not shown. For simplicity, only two cutting devices are shown; 13 is a rotary cutter similar to the cutter indicated by 3 in FIG. 2, and 18, 19 is an ultrasonic cutter similar to the cutter indicated by 7 in FIG. 2.

In FIG. 4 it is seen how the support 21 for the cutting devices takes the form of a frusto-conical framework with the active position topmost being occupied by the cutting device 28, 29 adjacent to the fabric F. An indexing mechanism to maintain this position is not shown. The other cutting device 23 is easily accessible from the side, because it is not only lowered, but also oriented parallel to the measuring or cutting table T. For simplicity, only two cutting devices are shown; 23 is a rotary cutter similar to the cutter indicated by 3 in FIG. 2, and 28, 29 is an ultrasonic cutter similar to the cutter indicated by 7 in FIG. 2.

The framework supports in FIGS. 3 and 4 may accommodate as many cutting devices as the periphery permits, provided that the positioning and indexing mechanisms are suitably adapted.

It is clear that the mounting principles displayed in the drawings may be equally applied to cutting from above the cutting table.

The invention has been described in some detail above, but this is not limiting per se, as the skilled person will be able to devise additional mechanical solutions that perform in an equivalent manner, thereby obtaining similar advantageous results.

The foregoing description of the specific embodiments will so fully reveal the general nature of the present invention that others skilled in the art can, by applying current knowledge, readily modify or adapt for various applications such specific embodiments without undue experimentation and without departing from the generic concept, and therefore, such adaptations and modifications should and are intended to be comprehended within the meaning and range of equivalents of the disclosed embodiments. It is to be understood that the phraseology or terminology employed herein is for the purpose of description and not of limitation. The means, materials, and steps for carrying out various disclosed functions may take a variety of forms without departing from the invention.

Thus, the expressions “means to . . . ” and “means for . . . ”, or any method step language, as may be found in the specification above and/or in the claims below, followed by a functional statement, are intended to define and cover whatever structural, physical, chemical, or electrical element or structure, or whatever method step, which may now or in the future exist which carries out the recited functions, whether or not precisely equivalent to the embodiment or embodiments disclosed in the specification above, i.e., other means or steps for carrying out the same function can be used; and it is intended that such expressions be given their broadest interpretation.

1. A machine for cutting fabric sheets for roller blinds, comprising a storage roll for roller blind fabric, a measuring table (T), means for immobilizing the fabric sheet, and cutting means travelling in an essentially straight line for cutting to size, characterized in that the cutting means consist of two or more cutting devices (3, 7) that are mounted on support means (1, 11, 21) interconnected in such a manner that only one cutting device at a time may be brought into an active position (5).

2. A machine according to claim 1, characterized in that the support means is a rotatable support in order that each cutting device may be brought into an active position by simple rotation (2, 12, 22) of the support (1, 11, 21).

3. A machine according to claim 2, characterized in that the cutting devices are placed on a plane support (1) rotatable around an axis (2) parallel to the plane of the measuring table and perpendicular to the line of cutting.

4. A machine according to claim 2, characterized in that the cutting devices are placed on a cylindrical support (11) rotatable around an axis 12) parallel to the plane of the measuring table (T) and perpendicular to the line of cutting.

5. A machine according to claim 2, characterized in that the cutting devices are placed on a support that forms part of a rotatable frusto-conical structure (21) in such a manner that each cutting device (23, 29) may be brought into the active position by rotating the conical support.

6. A machine according to any of the above claims, characterized in that the active position (5) for each of the cutting devices is essentially the same with respect to the other parts of the machine, irrespective of the actual cutting device brought into the active position.

7. A machine according to any of the above claims, characterized in that indexing means are provided to ensure secure positioning of each cutting device (3, 13, 23, 7, 19, 29) in the respective active positions.

8. A machine according to any of the above claims, characterized in that the cutting devices are brought into their active position by pneumatic means.

9. A machine according to any of the above claims, characterized in that the cutting devices are selected from the group consisting of rotating shears, hot wire, ultrasonic knife, high power laser, or water jet.

10. A use of the machine according to any one of the preceding claims in the manufacture of a roller blind, characterized in that it comprises the following steps:
a) unrolling of roller blind fabric from a storage roll until the end rests against a roller blind width determining ruler (R);
b) applying clamping means to clamp the fabric adjacent to the line of cutting;
c) bringing a cutting device into its active position dependent on the type of fabric to be cut;
d) performing the cutting by moving the cutting device across and through the fabric;
e) optionally repeating steps c) and d) for each type of fabric encountered during the cutting operation;
f) loosening the clamping means; and
g) transporting the cut fabric to a roller blind finishing station.
